(19) United States
(12) Patent Application Publication
(10) Pub. No.: US 2010/0329759 A1
(43) Pub. Date: Dec. 30, 2010

(54) SHEET LENGTH MEASURING APPARATUS, IMAGE FORMING APPARATUS, AND SHEET LENGTH MEASURING METHOD

(75) Inventors: Takao FURUYA, Kanagawa (JP); Yoshinari IWAKI, Kanagawa (JP); Kazuyuki TSUKAMOTO, Tokyo (JP); Minoru OHSHIMA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/617,317

(22) Filed: Nov. 12, 2009

(30) Foreign Application Priority Data
Jun. 25, 2009 (JP) 2009-151234

(51) Int. Cl. G03G 15/00; G01L 5/04

(52) U.S. Cl. 399/389; 73/159

(57) ABSTRACT

A sheet length measuring apparatus that includes: a rotating body that rotates in contact with a sheet delivered through a delivery path; detecting units that are located upstream and downstream of the rotating body respectively, and detect a position of the sheet delivered through the delivery path; a delivery unit that is located in at least one of positions between the detecting unit located upstream and the rotating body, and between the detecting unit located downstream and the rotating body, and delivers the sheet on the delivery path; and a rotation amount detecting unit that detects a rotation amount of the rotating body with using a period when the sheet is detected by the detecting units respectively located upstream and downstream of the rotating body as a measurement period.

### CROSS-REFERENCE TO RELATED APPLICATION

This application is based on and claims priority under 35 USC 119 from Japanese Patent Application No. 2009-151234 filed on Jun. 25, 2009.

### BACKGROUND

(i) Technical Field

The present invention relates to a sheet length measuring apparatus, an image forming apparatus, and a sheet length measuring method.

(ii) Related Art

There has been conventionally known an art that detects a sheet length of a sheet on which an image is formed.

### SUMMARY

According to an aspect of the present invention, there is provided a sheet length measuring apparatus including: a rotating body that rotates in contact with a sheet delivered through a delivery path; detecting units that are located upstream and downstream of the rotating body respectively, and detect a position of the sheet delivered through the delivery path; a delivery unit that is located in at least one of positions between the detecting unit located upstream and the rotating body, and between the detecting unit located downstream and the rotating body, and delivers the sheet on the delivery path; and a rotation amount detecting unit that detects a rotation amount of the rotating body with using a period when the sheet is detected by the detecting units respectively located upstream and downstream of the rotating body as a measurement period.

### BRIEF DESCRIPTION OF THE DRAWINGS

Exemplary embodiments of the present invention will be described in detail based on the following figures, wherein:

FIG. 1 is a block diagram illustrating a composition of a length measuring device in accordance with the first exemplary embodiment;

FIG. 2 is a diagram illustrating locations of an upstream delivery roll and a downstream delivery roll;

FIG. 3 is a diagram illustrating a composition of an image forming apparatus;

FIG. 4 is a diagram illustrating a connection configuration of a controller;

FIG. 5 is a diagram illustrating a hardware composition of a controller;

FIG. 6 is a flowchart illustrating a paper length measuring procedure by a controller;

FIGS. 7A and 7B are diagrams to explain a method of paper length calculation by a controller; FIG. 7A illustrates the time when a leading end of a paper arrives in a downstream edge sensor, and FIG. 7B illustrates the time when a posterior end gets out of an upstream edge sensor;

FIG. 8A illustrates an example of signal waveform that an upstream edge sensor, a downstream edge sensor, and a rotary encoder output, FIG. 8B is a diagram that enlarges a waveform of output signal from the downstream edge sensor and a rotary encoder around when the output signal of the downstream edge sensor is ON, and FIG. 8C is a diagram that enlarges a waveform of output signal from the upstream edge sensor and the rotary encoder around the time when the output signal of the upstream edge sensor is ON;

FIG. 9 is a diagram to explain a calculation method of a paper length by a controller;

FIGS. 10A through 10C are diagrams illustrating measuring procedures of a length measuring device of a related art; FIG. 10A illustrates the time when a leading end of a paper arrives in a downstream edge sensor, FIG. 10B illustrates the time when a leading end of a paper arrives in a downstream delivery roll, and FIG. 10C illustrates the time when a posterior end gets out of an upstream delivery roll;

FIG. 11 is a diagram illustrating timing when a delivered paper is detected by a sensor of a length measuring device and timing when a length of a paper is measured by a rotary encoder in the length measuring device of a related art;

FIG. 12 is a diagram illustrating timing when a delivered paper is detected by a sensor of a length measuring device and timing when a length of a paper is measured by a rotary encoder in the length measuring device of the exemplary embodiment;

FIG. 13 is a diagram illustrating a composition of a drive system of an upstream delivery roll;

FIGS. 14A and 14B are diagrams to explain an operating principle of a one-way clutch; FIG. 14A illustrates a condition that the one-way clutch transmits a rotation speed of a gear of the drive system to a rotating axis of an upstream delivery roll, and FIG. 14B illustrates a condition that the one-way clutch runs idle without transmitting a rotation of a rotating axis of an upstream delivery roll to a gear of the drive system; and

FIG. 15 is a diagram illustrating a composition of a length measuring device in accordance with the second exemplary embodiment.

### DETAILED DESCRIPTION

A description will now be given, with reference to the accompanying drawings, of exemplary embodiments of the present invention.

### First Exemplary Embodiment

(Description of an Example of a Composition of a Length Measuring Device)

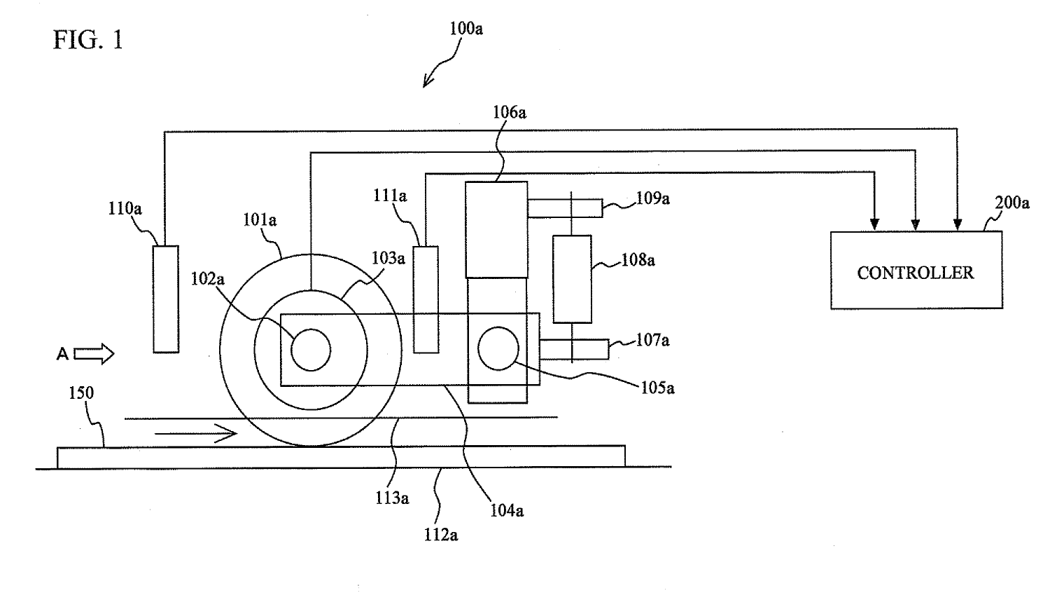

A composition of a length measuring device 100a in accordance with this exemplary embodiment will be described with reference to FIG. 1. The length measuring device 100a in accordance with this exemplary embodiment includes a length measuring roll (a rotating body) 101a which is an example of a rotating body for measuring. The length measuring roll 101a is cylindrical, and includes a rotating shaft 102a at the center of the length measuring roll 101a. The rotating shaft 102a of the length measuring roll 101a is provided with a rotary encoder (a rotation amount detecting unit) 103a that is an example of a unit to detect a rotation amount. The rotary encoder 103a generates pulse signal with respect to each predetermined rotating angle of the length measuring roll 101a. The pulse signal that the rotary encoder 103a outputs is transmitted to a controller 200 described later.

In addition, the rotating shaft 102a of the length measuring roll 101a is installed at one end of a swing arm 104a. The swing arm 104a keeps the rotating shaft 102a of the length measuring roll 101a rotatable. Another end of the swing arm 104a is attached to a swing arm supporting member 106a by a swing shaft 105a so that it is rotatable (swingably). The swing arm supporting member 106a is fixed to a chassis (not shown) of the length measuring device 100a.

An extension arm 107a is provided at the end of the opposite side to the side of the swing arm 104a in which the length measuring roll 101a is installed. One end of a coil spring 108a is attached to this extension arm 107a. Another side of the coil spring 108a is attached to an arm 109a that extends from the swing arm supporting member 106a. The coil spring 108a is tensioned, and generates the force to rotate the swing arm 104a in a counterclockwise direction in FIG. 1. The force to the counterclockwise direction in FIG. 1 is impressed upon the swing arm 104a by the coil spring 108a, so that the length measuring roll 101a is pressed on a delivery path (a lower chute 112a) of a paper 150 at a predetermined pressure.

The delivery path that delivers the paper 150 is provided with the lower chute 112a and an upper chute 113a that are located to face each other. The upper chute 113a is located in the position with predetermined clearance from the lower chute 112a. The lower chute 112a and the upper chute 113a are planar members respectively, and have a function to control the paper 150 being delivered. The paper 150 is delivered in contact with the lower chute 112a, and is controlled by the upper chute 113a so that the paper 150 is not displaced upward.

The paper 150 is a sheet-shaped record medium (a record sheet), and is a paper material on which an image is formed. In addition to paper materials, resin materials used for OHP sheets and paper sheets of which surfaces are coated with resin can be used as materials that compose the record medium.

An upstream edge sensor (a detecting unit) 110a is located upstream of the length measuring roll 101a, and a downstream edge sensor (a detecting unit) 111a is located downstream. Here, the paper 150 is delivered through the delivery path from the upstream edge sensor 110a side to the downstream edge sensor IIIa side. Therefore, the sensor located on the more upstream side than the length measuring roll 101a in the paper delivery direction is called an upstream edge sensor 110a, and a sensor located on the more downstream side than the length measuring roll 101a is called the downstream edge sensor 111a in the paper delivery direction.

The upstream edge sensor 110a and the downstream edge sensor 111a are photoelectronic sensors composed of an LED (Light Emitting Diode) and a photo sensor, and detect the passage of the delivered paper 150 at a detection position optically. Sensor signals output from the upstream edge sensor 110a and the downstream edge sensor 111a is transmitted to the controller 200. The controller 200 is a computer, and has a function that calculates a length of the paper 150 in the delivering direction, and a function as a controller of an image forming apparatus described later. These functions will be described later.

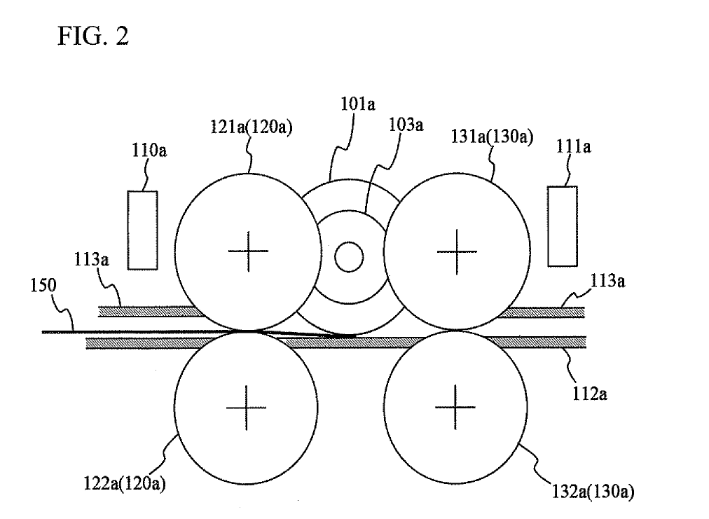

In addition, as illustrated in FIG. 2, the length measuring device 100a is provided with an upstream delivery roll (a delivery unit) 120a located on the upstream side in the paper delivery direction, and a downstream delivery roll (a delivery unit) 130a located on the downstream side in the paper delivery direction. The upstream delivery roll 120a is located between the upstream edge sensor 110a and the length measuring roll 101a. The downstream delivery roll 130a is located between the length measuring roll 101a and the downstream edge sensor 111a. The upstream delivery roll 120a includes a delivery roll 121a and a delivery roll 122a as a roll pair. In the same manner, the downstream delivery roll 130a includes a delivery roll 131a and a delivery roll 132a as a roll pair. The reason why the upstream delivery roll 120a is located between the upstream edge sensor 110a and the length measuring roll 101a and the reason why the downstream delivery roll 130a is located between the length measuring roll 101a and the downstream edge sensor 111a will be described in detail later. In addition, in FIG. 1, the upstream delivery roll 120a and the downstream delivery roll 130a are not illustrated. This is because the swing arm 104a, the swing shaft 105a, and the swing arm supporting member 106a are hidden by the upstream delivery roll 120a and the downstream delivery roll 130a if the upstream delivery roll 120a and the downstream delivery roll 130a are illustrated. Therefore the illustrations of the upstream delivery roll 120a and the downstream delivery roll 130a is omitted for convenience.

The delivery roll 122a of the upstream delivery roll 120a and the delivery roll 132a of the downstream delivery roll 130a are driven by a motor (not shown). In addition, the delivery roll 121a and the delivery roll 131a rotate with drive force of the delivery roll 122a and the delivery roll 132a respectively.

The length measuring roll 101a can be located in the side where the delivery rolls 122a and 132a are located against the paper 150 (the lower side than the paper 150 in FIG. 2, simply called “lower side” in this paragraph). However, in this exemplary embodiment, it is located in the side where the delivery rolls 121a and 131a are located (the upper side than the paper 150 in FIG. 2, simply called “upper side” in this paragraph). This is because a mechanism to drive the delivery rolls 122a and 132a needs to be located in not the upper side but the lower side. Therefore, there is more space in the upper side than the lower side.

(Description of an Example of a Composition of an Image Forming Apparatus)

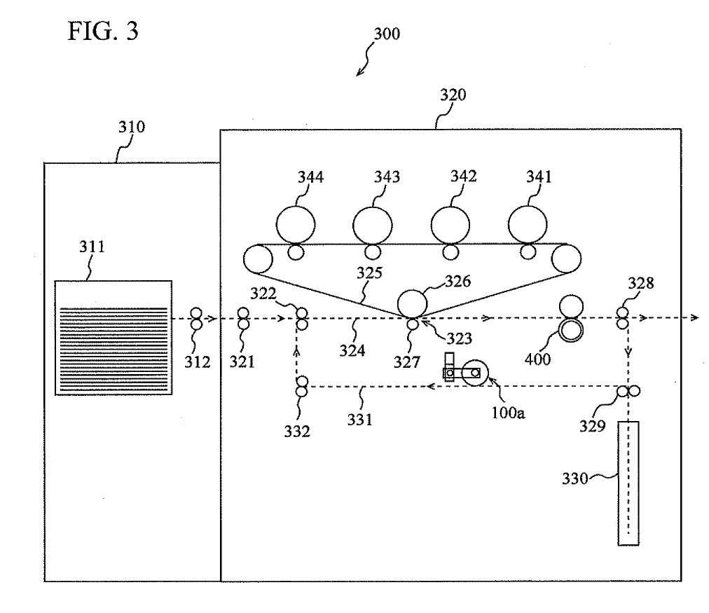

An example of an image forming apparatus 300 including the length measuring device 100a is illustrated in FIG. 3. The image forming apparatus 300 includes a paper feeding unit 310 that feeds the paper 150, and an image forming unit 320, and a fixing unit 400.

(Description of an Example of a Composition of a Paper Feeding Unit)

The paper feeding unit 310 is provided with a paper storage device 311 that stores multiple papers, a ejecting mechanism (not shown) that ejects papers to the delivery direction (to the image forming unit 320 side) from the paper storage device 311, and a delivery roll 312 that delivers papers ejected from the ejecting mechanism to the image forming unit 320.

(Description of an Example of a Composition of an Image Forming Unit)

The image forming unit 320 is provided with a delivery roll 321 which delivers the paper ejected from the paper feeding unit 310 to the inside of the image forming unit 320. A delivery roll 322 that delivers the paper 150, which is delivered by the delivery roll 321 or a delivery roll 332 described later, toward a second transfer unit 323 on a delivery path 324 is located upstream of the delivery roll 321. The second transfer unit 323 includes a transfer roll 326 and an opposite roll 327. The second transfer unit 323 transfers a toner image formed on a transfer belt 325 to the paper 150 by holding the transfer belt 325 and the paper 150 between the transfer roll 326 and the opposite roll 327.

The fixing unit 400 that fixes the toner image on the paper 150 to the paper 150 by heating and pressurization is located downstream of the second transfer unit 323. A delivery roll 328 is located downstream of the fixing unit 400. The delivery roll 328 delivers the paper 150 delivered by the fixing unit 400 to the outside of the device or a delivery roll 329.

When forming images on the both side of the paper 150, the delivery roll 328 delivers the paper 150 toward the delivery roll 329 after finishing forming the image on the first side of the paper 150. The paper 150 is delivered to a reversing device 330 by the delivery roll 329. The reversing device 330 returns the delivered paper 150 toward the delivery roll 329, and the delivery roll 329 delivers the paper 150 returned from the reversing device 330, to a delivery path 331.

The length measuring device 100a illustrated in FIGS. 1 and 2 is located in the delivery path 331. The length in the delivery direction of the paper 150 delivered to the delivery path 331 is measured by the length measuring device 100a. The measurement result by the length measuring device 100a is transmitted to the controller 200 illustrated in FIG. 1. Then, the paper 150 is delivered to the delivery path 324 by the delivery rolls 332 and 322. In this case, the front and back faces of the paper are reverse to the ones of the paper delivered to the delivery path 324 first. The paper 150 re-delivered through the delivery path 324 is delivered to the second transfer unit 323 again, and the image transfer to the second side which is a back side of the first side is executed.

Controls of a primary transfer processing and a second transfer processing of the image formed on the second side are executed on the basis of the length in the delivery direction of the paper measured by the length measuring device 100a. This is to reduce the phenomenon that the forming position of the image to be formed on the second side is displaced because of the dimensional change of the paper caused by the influence of the image formed on the first.

The image forming unit 320 includes primary transfer units 341, 342, 343, and 344. These primary transfer units 341 to 344 are provided with a photoconductor drum, a cleaning device, a charging device, an exposure device, a developing device, and a transfer roll respectively. Primary transfer units 341 to 344 transfer toner images of Y (Yellow), M (Magenta), C (Cyan), and K (Black) to the transfer belt 325 which is rotating, one by one on top of the other. A color toner image composed of YMCK toner images is formed on the transfer belt 325.

The control of the behavior of each component described above is executed by the controller 200. The controller 200 also executes the processing to measure the paper length. The controller 200 executes a control of the image forming processing based on the measured paper length, in time of the image forming processing to the second side in the case that the images are formed on the both sides of the paper.

In the composition illustrated in FIG. 3, the location of the length measuring device 100a can be upstream of the second transfer unit 323 in the delivery path 324, the length in the delivery direction of the paper can be measured before the image forming regardless of the front and back of the paper, and the information about the length can be used for the image forming.

(Description of an Example of a Composition of a Control System)

A control system of the image forming apparatus 300 illustrated in FIG. 3 will be described.

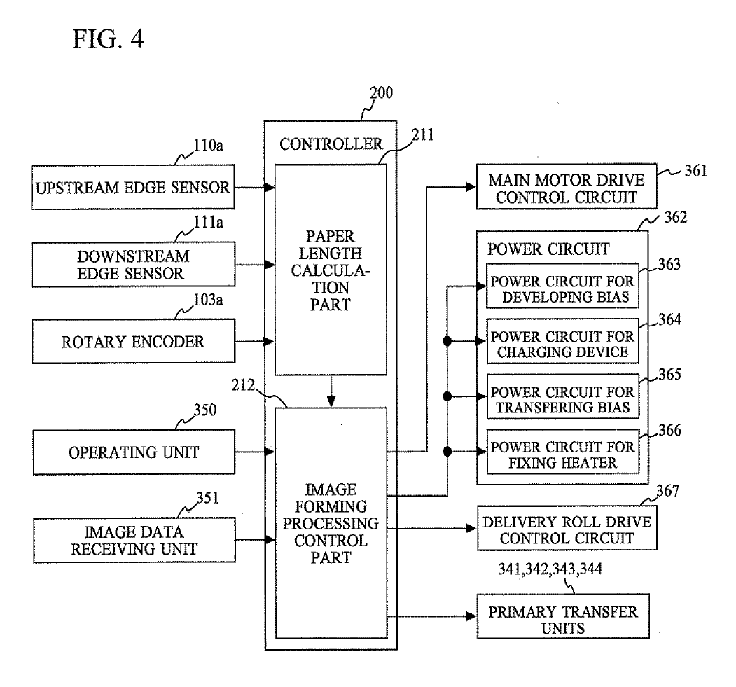

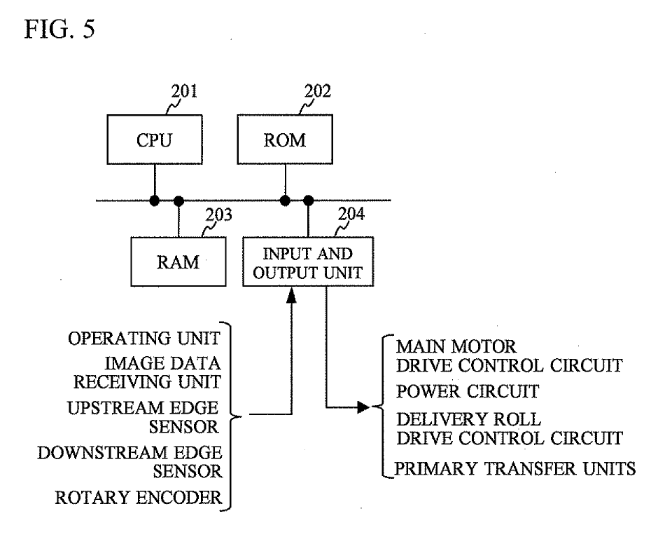

An example of the connection configuration of the controller 200 will be described with reference to FIG. 4. An operating unit 350, an image data receiving unit 351, the upstream edge sensor 110a, the downstream edge sensor 111a, the rotary encoder 103a, and the like are coupled to an input unit of the controller 200 (an input and output unit 204 illustrated in FIG. 5). In addition, a main motor drive control circuit 361, a power circuit 362, a delivery roll drive control circuit 367, primary transfer units 341 to 344, and the like are coupled to an output unit of the controller 200 (the input and output unit 204 illustrated in FIG. 5).

The operating unit 350 receives operating information input by the user. The operating unit 350 outputs the received operating information to the controller 200. The operating information includes the setting of a one-side printing or a duplex printing, and the setting of the number of printing, for example.

The image data receiving unit 351 acts as an input unit that receives the image data transmitted to the image forming apparatus 300 through the communication line (e.g. LAN) not shown. The image data receiving unit 351 outputs the received image data to the controller 200.

The upstream edge sensor 110a and the downstream edge sensor 111a detect the paper 150 delivered through the delivery path, and output a sensor signal that is ON while the paper 150 is detected, to the controller 200. The rotary encoder 103a generates a pulse signal with respect to each predetermined rotating angle when the length measuring roll 101a rotates. The pulse signal that the rotary encoder 103a outputs is also output to the controller 200.

Then, a device that is controlled by the controller and executes the image forming processing will be described.

The main motor drive control circuit 361 is a control circuit that controls a motor that rotates the transfer belt 325 in FIG. 3.

The power circuit 362 is provided with a power circuit for developing bias 363, a power circuit for a charging device 364, a power circuit for transferring bias 365, and a power circuit for a fixing heater 366. The power circuit for developing bias 363 generates the bias voltage energized in the time when the toner is provided from a developing device to a photo conductor in primary transfer units 341 to 344 in FIG. 3. The power circuit for the charging device 364 is a power circuit of the charging device that charges the photo conductor in primary transfer units 341 to 344. The power circuit for transferring bias 365 generates the bias voltage energized in time of the primary transfer to the transfer belt 325 in primary transfer units 341 to 344, and the bias voltage energized in the second transfer unit 323. The power circuit for the fixing heater 366 is a power source of an exothermic heater provided to the fixing unit 400.

The delivery roll drive control circuit 367 is a drive circuit that drives a motor that moves a roll of a ejecting mechanism to deliver the paper such as the delivery roll 322.

A hardware composition of the controller 200 will be described with reference to FIG. 5. An example of the hardware composition of the controller 200 is illustrated in FIG. 5. The controller 200 includes a CPU (Central Processing Unit) 201, a ROM (Read Only Memory) 202, a RAM (Random Access Memory) 203, and the input and output unit 204. A program that the CPU 201 uses for the control is stored in the ROM 202. The CPU 201 reads the program stored in the ROM 202, and stores the read program in the RAM 203. Then, the CPU 201 executes the processing according to the program stored in the RAM 203. The RAM 203 is used as a work area to store the data that the CPU 201 uses for calculation, and the calculation result data. The input and output unit 204 receives the data output from the operating unit 350, the image data receiving unit 351, the upstream edge sensor 110a, the downstream edge sensor 111a, the rotary encoder 103a, and the like. In addition, the input and output unit 204 outputs the control signal generated by the CPU 201 to the main motor drive control circuit 361, the power circuit 362, the delivery roll drive control circuit 367, and primary transfer units 341 to 344.

Then a functional block of the controller 200 implemented by the program control will be described with reference to FIG. 4. The controller 200 includes a paper length calculation part 211 and an image forming processing control part 212 as functional blocks. These functional blocks are implemented in the cooperation of the program stored in the ROM 202 and the hardware such as the CPU 201 and the RAM 203.

The paper length calculation part 211 has a calculation function to calculate the paper length, and stores the data processed with this calculation function in the RAM 203. The RAM 203 stores the data on a rotation amount of the length measuring roll 101a, the size data of the length measuring roll 101a, output information of the upstream edge sensor 110a and the downstream edge sensor 111a, information about the inter-sensor distance between the upstream edge sensor 110a and the downstream edge sensor 111a, and the like.

The image forming processing control part 212 controls the processing related to the image forming. The control object of the image forming processing control part 212 includes the main motor drive control circuit 361, the power circuit 362, the delivery roll drive control circuit 367, and primary transfer units 341 to 344.

(Description of Procedures of Paper Length Calculation by the Controller)

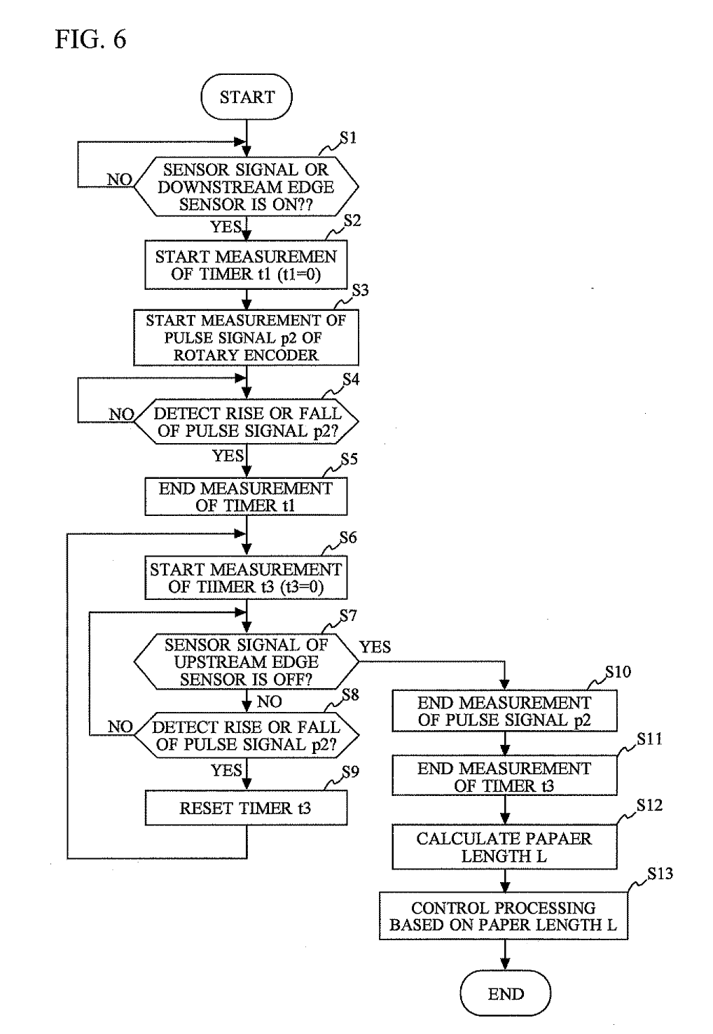

Then, an example of a control behavior of the controller 200 will be described with reference to a flowchart in FIG. 6. Here, the description of an example of the paper length calculation processing executed before the image forming onto the second side in the case the images are formed on both sides of the paper 150 will be described.

When forming the images on both sides of the paper 150, the paper is reversed in the reversing device 330 in FIG. 3, and delivered to the delivery path 331, after the image forming onto the first side. The processing illustrated in FIG. 6 is started at this timing.

The controller 200 determines whether the sensor signal of the downstream edge sensor 111a is ON (step S1). When the sensor signal of the downstream edge sensor 111a is ON (step S1/YES), the controller 200 goes to the step S2. When the sensor signal of the downstream edge sensor 111a is not ON(step S1/NO), it repeats the procedure of the step S1. When the sensor signal of the downstream edge sensor ilia is ON, it means that the leading end of the paper arrives at the detection position of the downstream edge sensor 111a.

When the downstream edge sensor 111a detects the paper 150 (step S1/YES), the controller 200 starts the measurement of the timer t1 (step S2). The controller 200 starts the measurement of the pulse signal p2 output from the rotary encoder 103a according to the start of the measurement of the timer t1 (step S3). When the controller 200 detects the change of the signal level of the pulse signal p2 (step 54), it ends the measurement of the timer 1 (step S5). At this time, the controller 200 acquires the counting value of the timer t1 as a measurement parameter t1, and stores it in the RAM 203.

Then, the controller 200 starts the measurement of the timer t3 from t 0 (step S6), and determines whether the sensor signal output from the upstream edge sensor 110a is OFF, which means whether the paper 150 passes the detection position of the upstream edge sensor 110a (step S7). When the sensor signal of the upstream edge sensor 110a is OFF (step S7/YES), the controller 200 ends the measurement of the pulse signal p2 (step S10). In addition, the controller 200 also ends the measurement of the timer t3 (step S11). At this time, the controller 200 acquires the counting value of the timer t3 as a measurement parameter t3, and stores it in the RAM 203.

Meanwhile, when the sensor signal from the upstream edge sensor 110a is not OFF in the step S7 (step S7/NO), the controller 200 determines whether the change of the signal level of the pulse signal p2 exists (step S8). When the controller 200 detects the change of the signal level of the pulse signal p2 (step S8/YES), the controller 200 resets the timer t3 (step S9), goes back to the step S7, and restarts the measurement of the timer t3. When the controller 200 does not detect the change of the signal level of the pulse signal p2 (step S8/NO), the controller 200 repeats the step S7 again.

The controller 200 calculates a paper length L after the step 511 (step S12). The controller 200 calculates the paper length L by adding up paper lengths from L1 to L4 described later. The controller 200 adjusts the forming position of the image formed on the second side of the paper on the basis of the calculated paper length L (step 513).

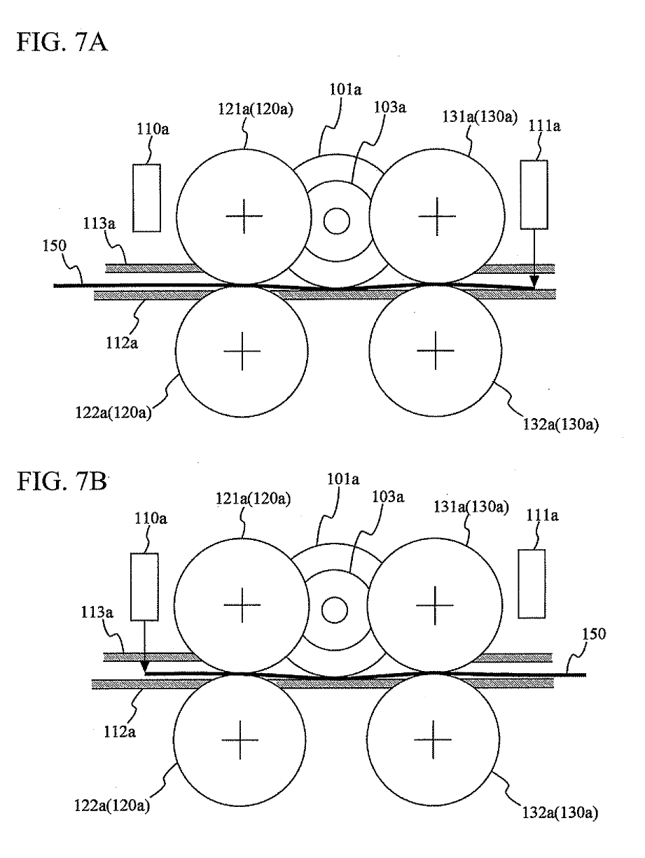

Here, paper lengths L1 through L4 will be described with reference to FIGS. 7A through 9.

The paper length L2 will be described first. The paper length L2 is a paper length calculated based on the counted number of the pulse signal p2 output from the rotary encoder 103a during the period when both the upstream edge sensor 110a and the downstream edge sensor 111a detect the paper 150 (hereinafter, called measurement period). The measurement start timing of the measurement period is when the sensor signal of the downstream edge sensor 111a becomes ON as the leading end of the paper 150 arrives at the detection position of the downstream edge sensor 111a (See FIG. 7A). In addition, the measurement end timing of the measurement period is when the sensor signal of the upstream edge sensor 110a becomes OFF as the posterior end of the paper 150 is pulled away from the detection position of the upstream edge sensor 110a (See FIG. 7B). The controller 200 calculates the paper length L2 based on the counted number of the pulse signal p2 counted during this measurement period.

The paper length L4 is a distance between the upstream edge sensor 110a and the downstream edge sensor 111a. As described above, the measurement of the paper length by the rotary encoder 103a is started after the leading end of the paper 150 arrives at the detection position. In addition, the measurement of the paper length by the rotary encoder 103a is not made after the posterior end of the paper 150 is pulled away from the detection position of the upstream edge sensor 110a. Therefore, it is necessary to add the distance from the measuring position of the rotary encoder 103a to the downstream edge sensor 111a before the measurement by the rotary encoder 103a, and the distance from the upstream edge sensor 110a to the measuring position of the rotary encoder 103a after the measurement by the rotary encoder 103a.

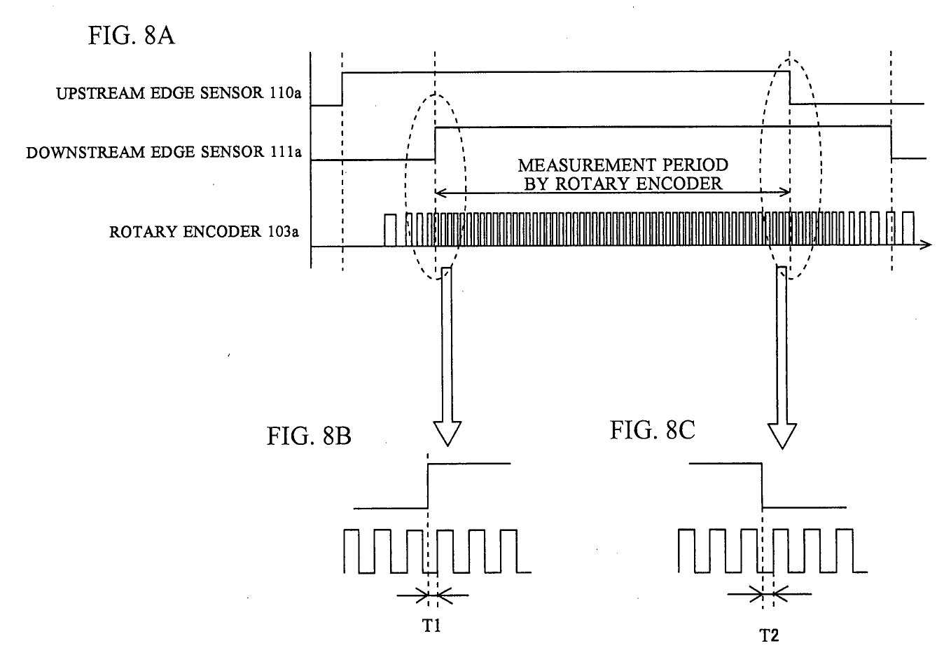

The paper length L1 and the paper length L3 are values to correct the error of measurement by the rotary encoder 103a. This error of measurement will be described with reference to FIGS. 8A through 8C. FIG. 8A illustrates a signal waveform of the pulse signal p2 output from the rotary encoder 103a, a signal level of the sensor signal of the upstream edge sensor 110a, and a signal level of the sensor signal of the downstream edge sensor 111a. FIG. 8B zooms the pulse signal p2 and the sensor signal of the downstream edge sensor 111a around the time when the sensor signal of the downstream edge sensor 11 is ON. In the same way, FIG. 8C zooms the pulse signal p2 and the sensor signal of the upstream edge sensor 110a around the time when the sensor signal of the upstream edge sensor 110a is OFF.

As illustrated in FIGS. 5A and 8B, it takes time from when the sensor signal of this sensor 111a becomes ON as the leading end of the paper 150 arrives at the detection position of the downstream edge sensor 111a till when the signal level of the pulse signal p2 output from the rotary encoder 103a changes. This is caused by the resolution of the rotary encoder 103a. The time from when the sensor signal of the downstream edge sensor 111a becomes ON till when the signal level of the pulse signal p2 of the rotary encoder 103a changes is the measurement value of the timer t1 described above. The controller 200 calculates the paper length L1 based on the measurement value of the timer t1.

In the same way, it takes time from when the sensor signal of this sensor 110a becomes OFF as the posterior end of the paper 150 is pulled away from the detection position of the upstream edge sensor 110a till when the signal level of the pulse signal p2 output from the rotary encoder 103a changes. The time from when the sensor signal of the upstream edge sensor 110a becomes OFF till when the signal level of the pulse signal p2 of a rotary encoder 103 changes is the measurement value of the timer t3 described above. The controller 200 calculates the paper length L3 based on the measurement value of the timer t3.

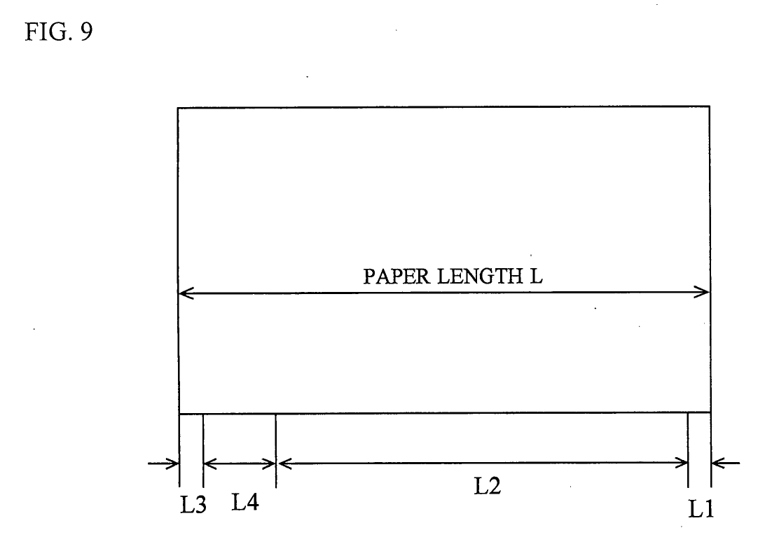

The controller 200 calculates the paper length L2 based on the counted number of the pulse signal p2 output from the rotary encoder 103 during the measurement period. In addition, the controller 200 calculates the paper length L1 by multiplying the measurement value of the timer t1 by the setting value V which is the delivery speed of the paper 150. In the same manner, the controller 200 calculates the paper length L3 by multiplying the measurement value of the timer t3 by the setting value V which is the delivery speed of the paper 150. Then, the controller 200 adds the value of the distance between the upstream edge sensor 110a and the downstream edge sensor 111a, which is stored in the RAM 203, to the value calculated by adding up calculated paper lengths L1, L2, and L3. A method to calculate the paper length L by adding up paper lengths from L1 to L4 is illustrated in FIG. 9.

(Description of a Detail Composition of the Length Measuring Device)

In the length measuring device 100a in accordance with this exemplary embodiment, as illustrated in FIG. 2, the upstream delivery roll 120a is located between the upstream edge sensor 110a and the length measuring roll 101a. In the same manner, the downstream delivery roll 130a is located between the length measuring roll 101a and the downstream edge sensor 111a. The reason why the upstream delivery roll 120a and the downstream delivery roll 130a are located at the position described above will be described.

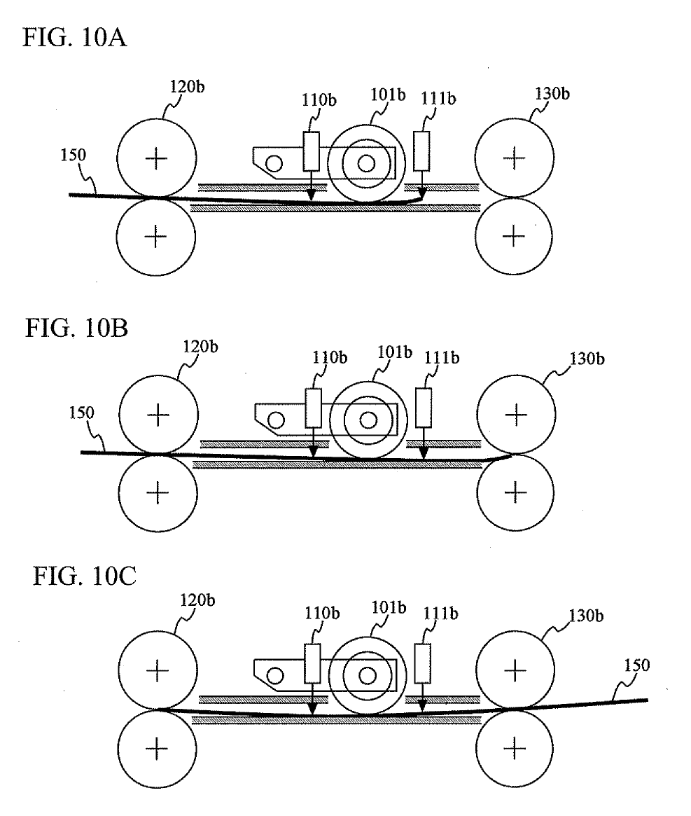

FIGS. 10A through 10C illustrate a composition of a length measuring device 100b of a related art. In the length measuring device 100b of a related art illustrated in FIGS. 10A through 10C, an upstream delivery roll 120b is located on the more upstream side than an upstream edge sensor 110b, and a downstream delivery roll 130b is located on the more downstream side than a downstream edge sensor 111b. Referring to FIGS. 10A through 10C, when the delivered paper is detected by the sensor of the length measuring device 100b and when the length of the delivered paper is measured by a rotary encoder 103b will be described.

As illustrated in FIG. 10A, when the leading end of the paper 150 delivered on the delivery path is detected by the downstream edge sensor 111b, a controller 200b starts counting the pulse signal of the rotary encoder 103b as described the flowchart above.

The paper 150 that passes the downstream edge sensor 111b is delivered on the delivery path by the upstream delivery roll 120b, and drawn into the downstream delivery roll 130b (See FIG. 10B). At this time, the delivery speed of the paper 150 can not be constant, and can be unsteady. For example, if a paper-slack exists between a length measuring roll 101b and the downstream delivery roll 130b, the delivery speed of the paper 150 may become fast when the paper 150 is drawn into the downstream delivery roll 130b. In addition, if the paper 150 is drawn into the downstream delivery roll 130b under the condition that a paper-slack does not exist between the length measuring roll 101b and the downstream delivery roll 130b, the delivery speed of the paper 150 may become slow as the length measuring roll 101b acts as a friction. Furthermore, the delivery speed of the paper 150 may become slow as the paper 150 being delivered hits the downstream delivery roll 130b.

When the delivery speed of the paper 150 becomes unsteady, the rotation of the length measuring roll 101b does not follow the delivery of the paper 150, and the length of the paper 150 can not be measured accurately.

As illustrated in FIG. 10C, the delivery speed may also be unsteady when the posterior end part of the paper 150 gets out of the upstream delivery roll 120b. For example, when the paper 150 gets out of the upstream delivery roll 120b, the paper 150 is drawn by the downstream delivery roll 130b and the delivery speed of the paper 150 may become fast because the paper 150 is released from the stress of the upstream delivery roll 120b.

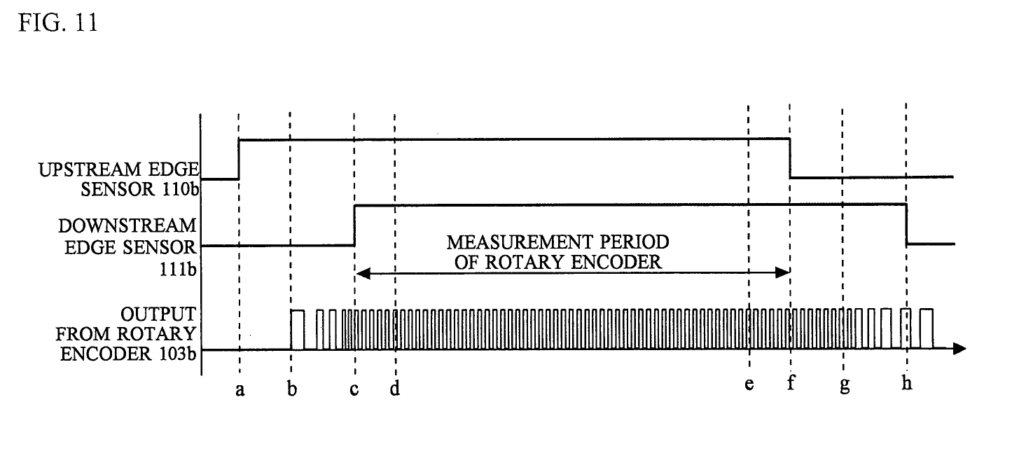

Output timings of sensor signals of the upstream edge sensor 110b and the downstream edge sensor 111b in the length measuring device 100b in FIG. 10 and an output timing of the pulse signal output from the rotary encoder 103b, are illustrated in FIG. 11.

As described above, in the length measuring device 100b of a related art, the downstream delivery roll 130b is located on the more downstream side than the downstream edge sensor 111b. Therefore, after the sensor signal becomes ON at the timing c illustrated in FIG. 11 as the leading end of the paper arrives at the detection position of the downstream edge sensor 111b, the leading end of the paper 150 is drawn by the downstream delivery roll 130b at the timing d illustrated in FIG. 11. Accordingly, after the rotary encoder 103b starts measuring the paper length, the paper 150 is drawn into the downstream delivery roll 130b.

In the same manner, in the length measuring device 100b of the related art, the upstream delivery roll 120b is located on the more upstream side than the upstream edge sensor 110b. Therefore, after the posterior end of the paper 150 gets out of the upstream delivery roll 120b at the timing e illustrated in FIG. 11, the posterior end of the paper 150 is pulled away from the detection position of the downstream edge sensor 111b at the timing f illustrated in FIG. 11. Accordingly, before the rotary encoder 103b finishes measuring the paper length, the paper 150 gets out of the upstream delivery roll 120b.

Therefore, the paper 150 is drawn into the downstream delivery roll 130b and gets out of the upstream delivery roll 120b while the rotary encoder 103b is measuring the paper length, so that the delivery speed of the paper 150 becomes unsteady.

In this exemplary embodiment, as illustrated in FIG. 2, the upstream delivery roll 120a is located between the upstream edge sensor 110a and the length measuring roll 101a, and the downstream delivery roll 130a is located between the downstream edge sensor 111a and the length measuring roll 101a. Because of the location described above, the paper 150 is not drawn into the downstream delivery roll 130a, and does not get out of the upstream delivery roll 120a while the rotary encoder 103a is measuring the paper length.

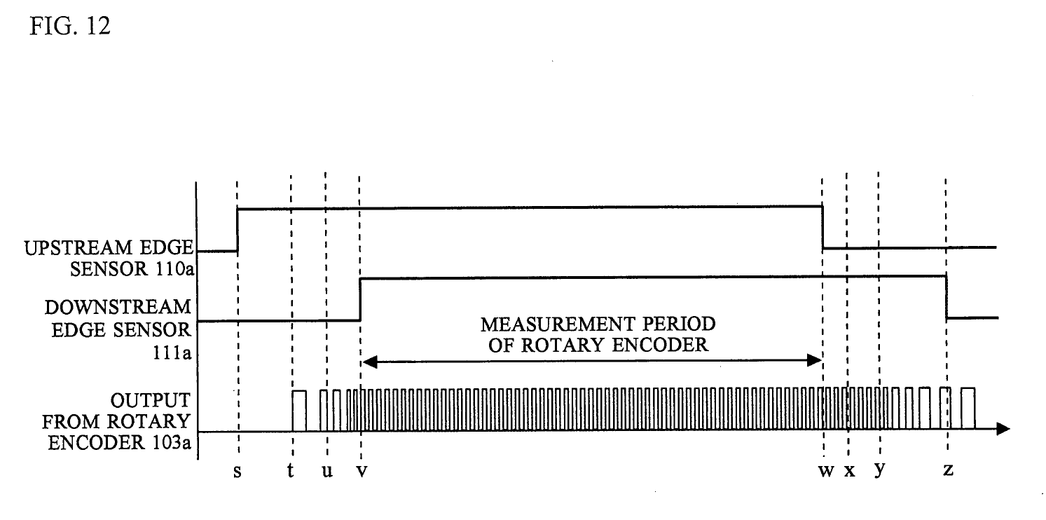

Output timings of sensor signals of the upstream edge sensor 110a and the downstream edge sensor 111a in the length measuring device 100a of this exemplary embodiment, and an output timing of the pulse signal that the rotary encoder 103a outputs are illustrated in FIG. 12.

As described above, in the length measuring device 100a of this exemplary embodiment, the downstream delivery roll 130a is located on the more upstream side than the downstream edge sensor 111a. Accordingly, the paper 150 arrives at the detection position of the downstream edge sensor 111a after passing the downstream delivery roll 130a. Therefore, after the paper 150 is drawn into the downstream delivery roll 130a at the timing u illustrated in FIG. 12, the paper 150 arrives at the detection position of the downstream edge sensor 111b at the timing v. Accordingly, after the paper 150 passes the downstream delivery roll 130a, the rotary encoder 103a starts measuring the paper length.

In addition, in the length measuring device 100a of this exemplary embodiment, the upstream delivery roll 120a is located on the more downstream side than the upstream edge sensor 110a. Accordingly, the posterior end of the paper 150 gets out of the upstream delivery roll 120a after being pulled away from the detection position of the upstream edge sensor 110a. Therefore, after the sensor signal of the upstream edge sensor 110a becomes OFF at the timing w illustrated in FIG. 12, the posterior end of the paper 150 gets out of the upstream delivery roll 120a at the timing x illustrated in FIG. 12.

As described above, according to the length measuring device 100a of this exemplary embodiment, the paper 150 is not drawn into the downstream delivery roll 130a, or does not get out of the upstream delivery roll 120a, during the length measurement.

To measure the paper length with the length measuring roll 101 with high accuracy, it is preferable that a paper-slack does not exist in the paper 150 of which the length is being measured by the rotary encoder 103a. However, if the delivery speed of the upstream delivery roll 120a is faster than the delivery speed of the downstream delivery roll 130a, the paper-slack may occur in the paper 150 between the upstream delivery roll 120a and the downstream delivery roll 130a. If the paper-slack exists in the paper 150 between the upstream delivery roll 120a and the downstream delivery roll 130a, the measurement accuracy of the rotary encoder 103 with the length measuring roll 101a will be reduced.

Thus, the rotation speed is set to be equal to or slightly faster than the rotation speed of the upstream delivery roll 120a. Normally, even though the rotation speed of the upstream delivery roll 120a is adjusted to be equal to the rotation speed of the downstream delivery roll 130a, their rotation speeds frequently do not become equal because of a dimension tolerance of the delivery roll. Therefore, the rotation speed of the downstream delivery roll 130a is adjusted to be faster than the rotation speed of the upstream delivery roll 120a with the dimension tolerance being taken into account. Because of this adjustment, the paper-slack that occurs in the paper 150 of which the length is being measured by the rotary encoder 103 will be reduced.

In addition, when the rotation speed of the downstream delivery roll 130a is faster than the rotation speed of the upstream delivery roll 120a, the paper 150 may be tensioned as the downstream delivery roll 130a may draw the paper 150. This will not be a problem if the tension is proper, but the paper 150 will be stressed if the tension is too much. Then, to reduce the stress on the paper 150, one of the delivery forces of the upstream delivery roll 120a and the downstream delivery roll 130a is set to be weaker than the delivery force of the other delivery roll. Because of this setting, a slip occurs between the delivery roll (120a or 130a), of which the delivery force is weaker than the other, and the paper 150. The delivery force of the delivery roll is defined by the product of the friction factor of the roll μ and the nip pressure of the roll N.

In addition, a one-way clutch can be located in the drive system of the upstream delivery roll 120a to reduce the stress on the paper 150.

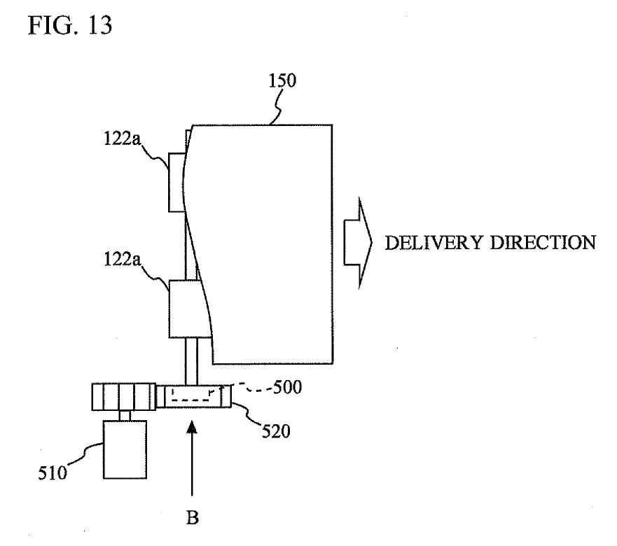

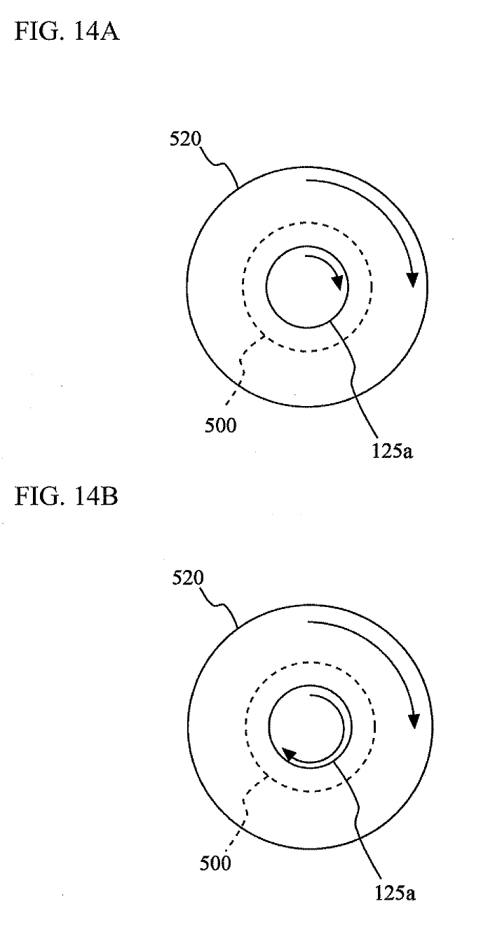

An example of a configuration using a one-way clutch as a drive system of the upstream delivery roll 120a is illustrated in FIG. 13. FIG. 13 illustrates only the delivery roll 122a, which rotates by the drive power of the motor, of the upstream delivery roll 120a. FIG. 14 illustrates a gear 520 included in the drive system of the upstream delivery roll 120a, seen from B direction.

The one-way clutch 500 is installed in the gear 520. A roll shaft 125a of the delivery roll 122a is embedded at the center of the one-way clutch 500. When the gear 520 rotates by the drive power of a motor 510, the one-way clutch 500 rotates, and rotates the roll shaft 125a of the delivery roll 122a (See FIG. 14A).

When the paper is drawn into the downstream delivery roll 130a by the downstream delivery roll 130a rotating at high speed, the paper drives the roll shaft 125a of the upstream delivery roll 120a, and the roll shaft 125a tends to rotate faster than the gear 520 being rotated by the drive power of the motor 510. This condition will be described in FIG. 14B. When the rotation speed of the roll shaft 125a becomes faster than the rotation speed of the gear 520, the one-way clutch 500 runs idle without engaging with the gear 520. Because the one-way clutch 500 runs idle against the gear 520, the friction that the upstream delivery roll 120a gives onto the paper 150 becomes small, and the stress on the paper 150 is reduced.

### Second Exemplary Embodiment

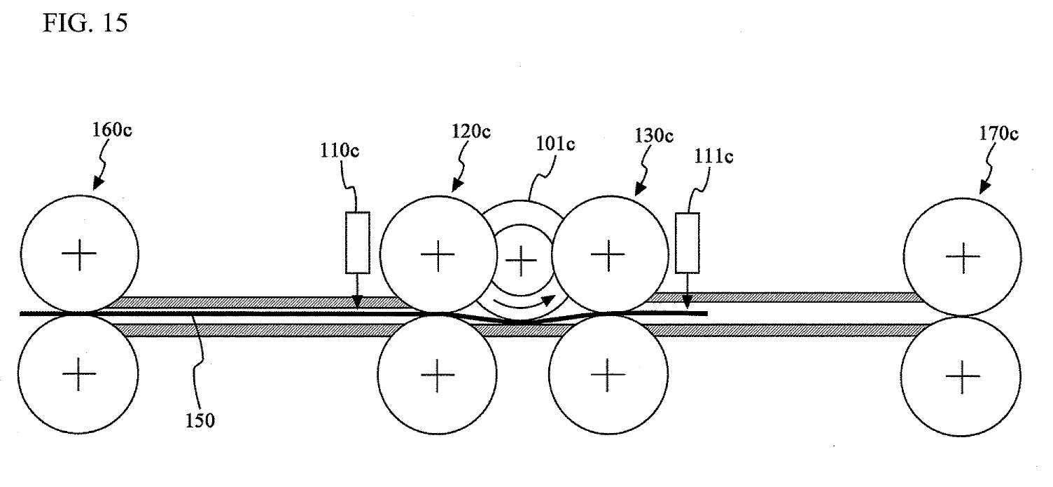

A second exemplary embodiment of the present invention will be described with reference to FIG. 15.

A second upstream delivery roll 160c is located upstream of an upstream edge sensor 110c in a length measuring device 100c of the present invention. In addition, in the same manner as the first exemplary embodiment, a first upstream delivery roll 120c (corresponding to the upstream delivery roll 120a in the first exemplary embodiment) is located between the upstream edge sensor 110c and a length measuring roll 101c.

Furthermore, a second downstream delivery roll 170c is located downstream of a downstream edge sensor 111c. In the same manner as the first exemplary embodiment, a first downstream delivery roll 130c (corresponding to the downstream delivery roll 130a in the first exemplary embodiment) is located between the length measuring roll 101c and the downstream edge sensor 111c.

In this exemplary embodiment, the delivery force of the first upstream delivery roll 120e is set to be equal to or stronger than the delivery force of the second upstream delivery roll 160e. In the same manner, the delivery force of the first downstream delivery roll 130c is set to be equal to or stronger than the delivery force of the second downstream delivery roll 170c.

When the delivery force of the second upstream delivery roll 160c is stronger than the delivery force of the first upstream delivery roll 120c, the influence that the posterior end of the paper 150 gets out of the second upstream delivery roll 160c (such as speed fluctuation) propagates to the paper 150 of which the length is being measured by the length measuring roll 101c. This is caused because the delivery force of the first upstream delivery roll 120c is weaker than the delivery force of the second upstream delivery roll 160c. Therefore, in this exemplary embodiment, the delivery force of the first upstream delivery roll 120c is set to be equal to or stronger than the delivery force of the second upstream delivery roll 160c.

In the same manner, the delivery force of the second downstream delivery roll 170c is stronger than the delivery force of the first downstream delivery roll 130e, the influence that the leading end of the paper 150 is drawn into the second downstream delivery roll 170c (a speed fluctuation) is propagated to the paper 150 of which the length is being measured by the length measuring roll 101c. This is caused because the delivery force of the first downstream delivery roll 130c is weaker than the delivery force of the second downstream delivery roll 170c. Therefore, in this exemplary embodiment, the delivery force of the first downstream delivery roll 130c is set to be equal to or stronger than the delivery force of the second downstream delivery roll 170c.

According to this exemplary embodiment, when two delivery rolls are located upstream of the length measuring roll 101c, the delivery force of the first upstream delivery roll 120c located on the downstream side is set to be equal to or stronger than the delivery force of the second upstream delivery roll 160c located on the upstream side. Because of these settings, the change of the delivery force propagated to the paper 150 is reduced.

In the same manner, when two delivery rolls are located downstream of the length measuring roll 101c, the deliver force of the first downstream delivery roll 130c located on the upstream side is set to be equal to or stronger than the delivery force of the second downstream delivery roll 170c located on the downstream side. Because of these settings, the change of the delivery force propagated to the paper 150 is reduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A sheet length measuring apparatus comprising:
a rotating body that rotates in contact with a sheet delivered through a delivery path;
detecting units that are located upstream and downstream of the rotating body respectively, and detect a position of the sheet delivered through the delivery path;
a delivery unit that is located in at least one of positions between the detecting unit located upstream and the rotating body, and between the detecting unit located downstream and the rotating body, and delivers the sheet on the delivery path; and
a rotation amount detecting unit that detects a rotation amount of the rotating body with using a period when the sheet is detected by the detecting units respectively located upstream and downstream of the rotating body as a measurement period.

2. The sheet length measuring apparatus according to claim 1, wherein the delivery unit is located in both positions that are between the detecting unit located upstream and the rotating body, and between the detecting unit located downstream and the rotating body.

3. The sheet length measuring apparatus according to claim 2, wherein:
the delivery units include delivery rolls that deliver a sheet by a rotation of a roll; and
a rotation speed of the delivery roll located downstream is equal to or greater than a rotation speed of the delivery roll located upstream.

4. The sheet length measuring apparatus according to claim 3, wherein the delivery roll located upstream has a delivery force different from that of the delivery roll located downstream.

5. The sheet length measuring apparatus according to claim 2, further comprising:
a gear that rotates by a drive of a motor; and
a one-way clutch that is installed in the gear, and transmits a rotation of the gear to a roll shaft of the delivery roll located upstream, in a drive transmit unit that rotary drives the delivery roll located upstream,
wherein the one-way clutch runs idle without engaging with the gear when a rotation speed of the roll shaft becomes faster than a rotation speed of the gear.

6. A sheet length measuring apparatus comprising:
a rotating body that rotates in contact with a sheet delivered through a delivery path;
detecting units that are located upstream and downstream of the rotating body respectively, and detect a position of the sheet delivered through the delivery path;
a first upstream delivery roll located between the detecting unit located upstream and the rotating body, and delivers a sheet on the delivery path;
a second upstream delivery roll located on the more upstream side than the detecting unit located upstream, and delivers a sheet on the delivery path;
a first downstream delivery roll located between the detecting unit located downstream and the rotating body, and delivers a sheet on the delivery path;
a second downstream delivery roll located on the more downstream side than the detecting unit located downstream, and delivers a sheet on the delivery path; and
a rotation amount detecting unit that detects a rotation amount of the rotating body with using a period when the sheet is detected by the detecting units located upstream and downstream of the rotating body respectively as a measurement period,
wherein a delivery force of the first upstream delivery roll is equal to or stronger than a delivery force of the second upstream delivery roll, and a delivery force of the first downstream delivery roll is equal to or stronger than a delivery force of the second downstream delivery roll.

7. An image forming apparatus comprising:
a sheet length measuring apparatus including:
a rotating body that rotates in contact with a sheet delivered through a delivery path;
detecting units that are located upstream and downstream of the rotating body respectively, and detect a position of the sheet delivered through the delivery path;
a delivery unit that is located in at least one of positions between the detecting unit located upstream and the rotating body, and between the detecting unit located downstream and the rotating body, and delivers the sheet on the delivery path; and
a rotation amount detecting unit that detects a rotation amount of the rotating body with using a period when the sheet is detected by the detecting units respectively located upstream and downstream of the rotating body as a measurement period; and
an image forming unit that controls a forming condition of an image formed on the sheet on the basis of an output of the sheet length measuring apparatus.

8. An image forming apparatus comprising:
a sheet length measuring apparatus including:
a rotating body that rotates in contact with a sheet delivered through a delivery path;
detecting units that are located upstream and downstream of the rotating body respectively, and detect a position of the sheet delivered through the delivery path;
a first upstream delivery roll located between the detecting unit located upstream and the rotating body, and delivers a sheet on the delivery path;
a second upstream delivery roll located on the more upstream side than the detecting unit located upstream, and delivers a sheet on the delivery path;
a first downstream delivery roll located between the detecting unit located downstream and the rotating body, and delivers a sheet on the delivery path;
a second downstream delivery roll located on the more downstream side than the detecting unit located downstream, and delivers a sheet on the delivery path; and
a rotation amount detecting unit that detects a rotation amount of the rotating body with using a period when the sheet is detected by the detecting units located upstream and downstream of the rotating body respectively as a measurement period; and
an image forming unit that controls a forming condition of an image which is formed on the sheet on the basis of an output of the sheet length measuring apparatus,
wherein a delivery force of the first upstream delivery roll is equal to or stronger than a delivery force of the second upstream delivery roll, and a delivery force of the first downstream delivery roll is equal to or stronger than a delivery force of the second downstream delivery roll.

9. A sheet length measuring method comprising:
rotating a rotating body in contact with a sheet delivered through a delivery path;
detecting a position of the sheet delivered through the delivery path with detecting units that are located upstream and downstream of the rotating body respectively;
delivering the sheet on the delivery path with a delivery unit located in at least one of positions between the detecting unit located upstream and the rotating body, and between the detecting unit located downstream and the rotating body; and
detecting a rotation amount of the rotating body with using a period when the sheet is detected by the detecting units located upstream and downstream of the rotating body as a measurement period.
